(19) United States
(12) Patent Application Publication
(10) Pub. No.: US 2025/0335221 A1
(43) Pub. Date: Oct. 30, 2025

(54) VIRTUAL DESKTOP AFFINITY FOR SEAMLESS REMOTE DESKTOP WINDOWS

(71) Applicant: Omnissa, LLC, Mountain View, CA (US)

(72) Inventor: Alexander V. Danilychev, Irvine, CA (US)

(21) Appl. No.: 18/645,151

(22) Filed: Apr. 24, 2024

(51) Int. Cl. G06F 9/451; G06F 40/117

(52) U.S. Cl. CPC G06F 9/452; G06F 40/117

(57) ABSTRACT

An example method of displaying windows in a remote desktop system, includes: obtaining, by a remote desktop client executing on a local computer having a local operating system (OS), information relating a first window to a first virtual desktop generated by the local OS; sending the information from the remote desktop client to a remote desktop server; setting, by the remote desktop server, a tag in a remote window object representing a remote window that corresponds to the first window based on the information, the remote window generated by a remote OS on a remote computer; receiving, at the remote desktop client, at least a portion of the remote window object including the tag; and displaying, by the remote desktop client in cooperation with the local OS based on the tag, the first window on the first virtual desktop.

### BACKGROUND

Remote desktops allow users to access and control one computer (referred to herein as the “remote computer”) from another computer (referred to herein as the “local computer”) over a network connection. As used herein, a “computer” includes desktop computers, laptops, servers, tablets, mobile phones, IoT devices, and other programmable electronic devices capable of storing, retrieving, and processing data. A desktop is the primary graphical user interface (GUI) generated by an operating system (OS) executing on a computer. A desktop generated by an OS on a remote computer is referred to herein as a “remote desktop.” A desktop generated by an OS on a local computer is referred to herein as a “local desktop.” The OS on the local computer is referred to herein as the “local OS.” The OS on the remote computer is referred to herein as the “remote OS.”

Remote desktop systems allow a user to perform tasks, access files, execute applications, and the like on the remote computer as if the user was interacting directly with the remote computer. Remote desktop systems implement the concept of “screen sharing,” wherein the remote computer transmits to the local computer all or a portion of the remote desktop for display to the user at the local computer. Remote desktop systems further implement the concept of “input forwarding,” wherein the local computer sends keyboard, mouse, touch screen, and the like inputs to the remote computer allowing the user to control the remote desktop. A remote desktop system comprises software executing on the remote computer, referred to herein as a “remote desktop server,” and software executing on the local computer, referred to herein as a “remote desktop client.”

A user may authenticate with the remote desktop system to establish a connection between the remote desktop client on the local computer and the remote desktop server on the remote computer (referred to herein as a “remote desktop session”). In a traditional remote desktop session, the local OS displays the entire remote desktop within a window on the local desktop. A window may include a graphical control element that displays the contents of an application within an area of a desktop. Windows can be moved, resized, minimized, maximized, closed, and the like by the user. In another type of remote desktop system, windows on the remote desktop appear as if they are running directly on the user's local desktop (such as system is referred to herein as being “seamless”). Thus, in a seamless system, a window on the local desktop (referred to herein as a “seamless window”) shows the contents of a corresponding window on the remote desktop (referred to herein as a “remote window”). Windows of the local desktop other than seamless windows are referred to herein as “local windows.” In a seamless remote desktop system, seamless windows may be integrated with the local desktop's GUI elements, such as a taskbar, start menu, and the like, and are displayed side-by-side with local windows.

An OS executing on a computer can manage multiple virtual desktops. Virtual desktops allow a user to expand their workspace across multiple, separate desktops on the same computer (referred to herein as “virtual desktops”). Typically the OS displays only one of the virtual desktops to the user as selected by the user (referred to herein as the “active desktop”). The OS allows the user to switch between virtual desktops through keyboard shortcuts, swipe gestures, GUI elements, mouse clicks, or the like. As used herein, a “virtual desktop” differs from a “remote desktop.” A virtual desktop comprises a local desktop generated by the local OS of the local computer. A remote desktop comprises a desktop generated by the remote OS of a remote computer.

In a remote desktop session, when the user performs an action that opens a new remote window on the remote desktop, the remote desktop client can generate a new seamless window on the local desktop to display the contents of the remote window. The local OS positions the new seamless window on the active desktop being one of multiple virtual desktops generated by local OS. The user can thereafter reposition the seamless window to a different virtual desktop being another one of the multiple virtual desktops generated by the local OS. The remote desktop session can then be interrupted, either directly by the user, or due to network disruption. For example, the user can intentionally interrupt the remote desktop session on one local computer and reconnect to the remote desktop session from another local computer. In case of loss of network connection, the user can reconnect the remote desktop session from the same computer once the network connection has been restored. Once the remote desktop session is resumed, the local desktop client will display all seamless windows on the active desktop. This can be jarring to the user, who might have positioned different seamless windows across different virtual desktops, and who is now faced with all seamless windows being positioned on one of the virtual desktops.

### SUMMARY

In an embodiment, a method of displaying windows in a remote desktop system is described. The method includes obtaining, by a remote desktop client executing on a local computer having a local operating system (OS), information relating a first window to a first virtual desktop generated by the local OS. The method includes sending the information from the remote desktop client to a remote desktop server. The method includes setting, by the remote desktop server, a tag in a remote window object representing a remote window that corresponds to the first window based on the information, the remote window generated by a remote OS on a remote computer. The method includes receiving, at the remote desktop client, at least a portion of the remote window object including the tag. The method includes displaying, by the remote desktop client in cooperation with the local OS based on the tag, the first window on the first virtual desktop.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a computing system according to embodiments.

FIG. 2 is a schematic representation of local and remote windows in a remote desktop environment according to embodiments.

FIG. 3 is a schematic representation of local and remote windows in a remote desktop environment according to embodiments.

FIG. 4 is a flow diagram depicting a method of establishing a remote desktop session according to embodiments.

FIG. 5 is a block diagram depicting remote window tagging according to embodiments.

FIG. 6 is a flow diagram depicting a method of reestablishing a remote desktop session after interruption according to embodiments.

FIG. 7 is a flow diagram depicting a method of establishing a remote desktop session according to some embodiments.

### DETAILED DESCRIPTION

A desktop may be a graphical user interface (GUI). A remote desktop session (also referred to as a remote session) may be a connection between a client, referred to as a remote desktop client (or remote client), and a server, referred to as a remote desktop server (or remote server), over a network. A remote session may be associated with a login session for a user, where a login session may be a period between a login for a user to an operating system (OS) and a logout for a user from the OS. The remote desktop client may be software executing on a computer, referred to as a local computer. The remote desktop server may be software executing on a computer, referred to as a remote computer. A local desktop may be a GUI generated by a local operating system (OS) of the local computer. A remote desktop may be a GUI generated by a remote OS of the remote computer for a remote desktop session. The remote desktop server may establish multiple remote sessions concurrently (e.g., for login sessions of multiple users) and hence remote OS can generate multiple remote desktops concurrently. The remote desktop client and the remote desktop server use one or more protocols to exchange information over the remote desktop session, including information for displaying at least a portion of the remote desktop on the local desktop.

The remote OS on the remote desktop server may generate its own local desktop referred to as a console. The console of the remote OS may be a desktop that would be displayed if a monitor was attached to the remote desktop server. The remote desktop client can establish a console session with the remote desktop server. A console session may be access to the console of the remote OS. While the remote desktop server can support multiple remote sessions concurrently, there may be support for only a single console session. Console sessions can be used for exclusive, administrative control as if a user were physically present at the remote server, while remote desktop sessions can provide multiple users with concurrent, isolated access to the server's resources.

In some embodiments, the remote desktop client cooperates with the local OS to display seamless windows. A window may be a portion of a desktop that presents content of an application. A seamless window may be a window on the local desktop that shows the contents of a corresponding window on the remote desktop. This is in contrast with a traditional remote desktop session, where the entire remote desktop is displayed within a window on the local desktop. With a seamless window, a remote application can be integrated into the local desktop environment, displaying only the application window without the remote desktop's background, taskbar, etc. that are external to the application window.

In some embodiments, the local OS supports virtual desktops. A virtual desktop may be a desktop that shares physical resources with other virtual desktops. For example, a local OS can receive commands to select a virtual desktop for presentation on a display and then switch to a different virtual desktop for presentation on the display. With virtual desktops, a user can expand their workspace across multiple, separate virtual desktops, which share physical display(s).

Virtual desktop affinity for seamless remote desktop windows is described. As used herein, affinity means a relationship (e.g., a seamless window can be related to a virtual desktop). In some embodiments, the remote desktop client obtains information relating a first window to a virtual desktop generated by the local OS. The first window may be a seamless window that shows the contents of a corresponding window on the remote desktop. The remote desktop client sends this information to the remote desktop server. The remote desktop server sets a tag in a remote window object representing the remote window based on the information. The remote window object may be a data object maintained by the remote OS for the remote window and the tag may be a field of the data object. The remote window object can include procedures for setting the tag and getting the value of the tag. In this manner, the remote desktop server relates the remote window to a virtual desktop generated by the local OS. For example, the remote desktop server remembers on which virtual desktop the user has positioned the first window that shows the contents of the remote window.

At some point, the remote session can be reconnected (e.g., after a network disruption or intentional interruption). The remote desktop client receives at least a portion of the remote window object from the remote desktop server. The remote desktop client cooperates with the local OS to display, based on the tag, the first window on the virtual desktop. That is, the remote desktop client and the remote desktop server cooperate to maintain a virtual desktop affinity for the first window. These and further aspects are described below with respect to the drawings.

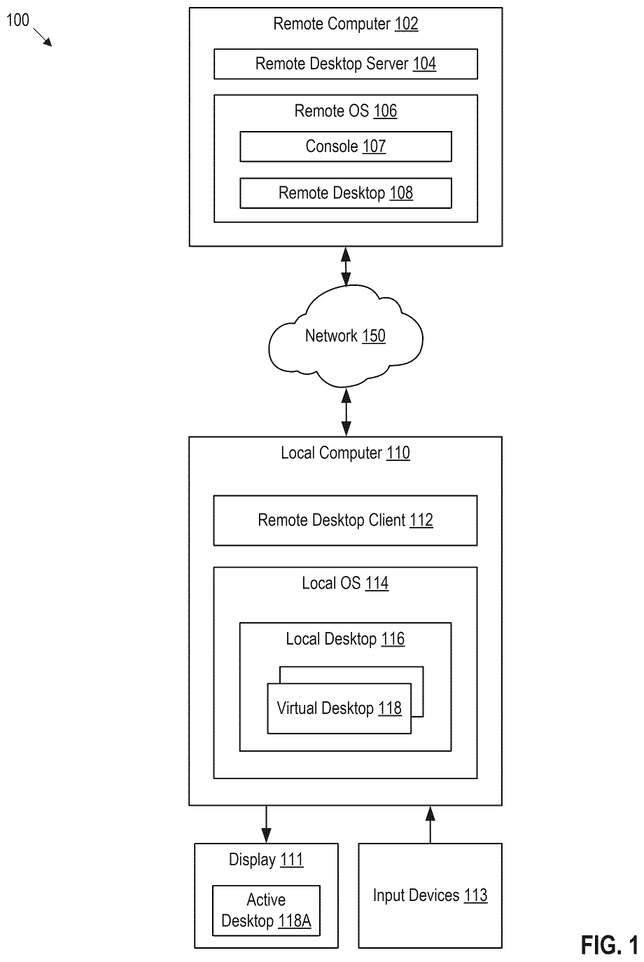

FIG. 1 is a block diagram depicting a computing system 100 according to some embodiments. Computing system 100 includes a remote computer 102 and a local computer 110 connected to a network 150, such as a wide area network (WAN) (e.g., the public Internet), local area network (LAN) (e.g., corporate or home network), or the like. Remote computer 102 can be a physical computer comprising a hardware platform (e.g., x86 architecture platform, ARM architecture platform, etc.) on which software executes. Alternatively, remote computer 102 can be a virtual machine (VM), container, or other type of virtual computing instance executing on a physical computer. The software executing on remote computer 102 includes remote operating system (OS) 106 and remote desktop server 104. Remote OS 106 can be any operating system known in the art (e.g., WINDOWS, LINUX, etc.). Remote desktop server 104 handles remote desktop sessions from remote desktop clients. Remote OS 106 generates a desktop referred to as remote desktop 108 for each remote desktop session. Remote OS 106 can also generate a console 107.

Local computer 110 can be a physical computer (e.g., desktop computer, mobile device, etc.) comprising a hardware platform on which software executes. Alternatively, local computer 110 can be a VM, container, or other type of virtual computing instance executing on a physical computer. The hardware platform of local computer 110 can be connected to a display 111 (e.g., a monitor, a touch screen, etc.) and input devices 113 (e.g., a keyboard, a mouse, a touch screen, etc.). The software executing on local computer 110 includes local OS 114 and remote desktop client 112. Local OS 116 can be any operating system known in the art.

Remote desktop client 112 cooperates with remote desktop server 104 to establish a remote desktop session between local computer 110 and remote computer 102. The remote desktop session may be associated with a login session for a user. Remote desktop server 104 can establish multiple remote desktop sessions concurrently with multiple clients (e.g., for login sessions of multiple users). Remote desktop client 112 and remote desktop server 104 exchange information over the remote desktop session, including information for displaying all or a portion of remote desktop 108 on local desktop 116, as well as information conveying input received at local computer 110 (e.g., keyboard input, mouse input, touch screen input, etc.). As described further herein, remote desktop client 112 cooperates with local OS 114 to display some or all of remote desktop 108 on local desktop 116, including the display of seamless windows. A seamless window may be a window on local desktop 116 that shows the contents of a corresponding remote window on remote desktop 108. Seamless windows can be integrated with the local desktop's GUI elements, such as a taskbar, start menu, and the like, and are displayed side-by-side with local windows.

Local OS 114 can generate multiple virtual desktops 118. Local OS 114 can cooperate with the hardware platform of local computer 110 to present a virtual desktop on display 111. Display 111 supports an array of physical pixels having a width and height (e.g., 1920 pixels wide by 1080 pixels height). Local OS 114 can present a desktop on display 111 such that the desktop encompasses all or a majority of the active physical pixels. Active physical pixels are those that receive a signal from the hardware platform of local computer 110. Local OS 114 generates virtual desktops 118 and cooperates with the hardware platform of local computer 110 to present all or a portion of virtual desktops 118 on display 111. For example, local OS 114 can present multiple virtual desktops 118 on display 111, such as in a “birds-eye” view or the like that allows a user to select an active desktop 118A among virtual desktops 118. In such case, each virtual desktop 118 encompasses only a minority subset of the active physical pixels display 111 such that multiple virtual desktops 118 can be presented concurrently. Other than specialized presentation modes such as the birds-eye view or “snapping regions” (discussed further herein), local OS 114 presents active desktop 118A on display 111. Local OS 114 can select one of virtual desktops 118 as an active desktop 118A (e.g., through user interaction). Active desktop 118A may be a desktop generated by local OS 114 and presented on display 111 to encompass all or a majority of the active physical pixels of display 111, which can be one of virtual desktops 118.

In the example of FIG. 1, remote desktop server 104 executes on remote computer 102 having remote desktop 108. Embodiments described herein can be deployed using more complex remote desktop systems. For example, remote desktop server 104 can execute in one remote computer and provide service to multiple other remote computers as a gateway. Multiple users can interact with such a gateway remote desktop server, which in turn interacts with remote operating systems of remote computers to maintain remote desktops for the multiple users. For purposes of clarity by example, embodiments are described with respect to the simplified system shown in FIG. 1 but are not so limited. In some embodiments described herein, virtual desktops comprise desktops and the remote desktop system maintains affinities between seamless windows and virtual desktops.

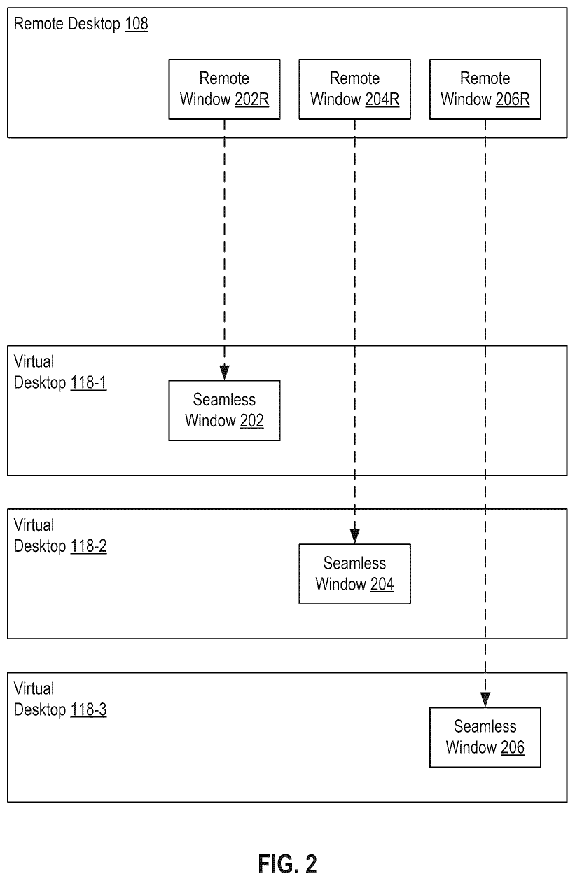

FIG. 2 is a schematic representation of local and remote windows in a remote desktop environment according to some embodiments. A user interacts with remote desktop client 112 to establish a remote desktop session with remote desktop server 104. For purposes of clarity by example, some actions are described as being performed by a user. It is to be understood that software can take the place of the user and be the entity that performs the actions attributed to the user (e.g., artificial intelligence (AI) software or the like). In response to establishing the remote desktop session, remote desktop server 104 cooperates with remote OS 106 to generate remote desktop 108. A user interacts with remote desktop client 112 and/or local OS 114 that results in remote OS 106 creating three remote windows on remote desktop 108, which are designated remote window 202R, remote window 204R, and remote window 206R. For example, the user can launch one or more applications that result in generation of remote windows 202R, 204R, and 206R on remote desktop 108. Remote desktop server 104 cooperates with remote desktop client 112 to generate seamless windows corresponding to the remote windows, namely, seamless windows 202, 204, and 206 that correspond with remote windows 202R, 204R, and 206R, respectively. Remote desktop client 112 cooperates with local OS 114 to display seamless windows 202, 204, and 206 on local desktop 116. In the example of FIG. 2, local desktop 116 includes three virtual desktops 118, which are designated virtual desktop 118-1, virtual desktop 118-2, and virtual desktop 118-3. Local OS 114 displays seamless window 202 on virtual desktop 118-2, seamless window 204 on virtual desktop 118-2, and seamless window 206 on virtual desktop 118-3. For example, a user can interact with local OS 114 to assign seamless windows 202 . . . 206 to their respective virtual desktops 118-1 . . . 118-3.

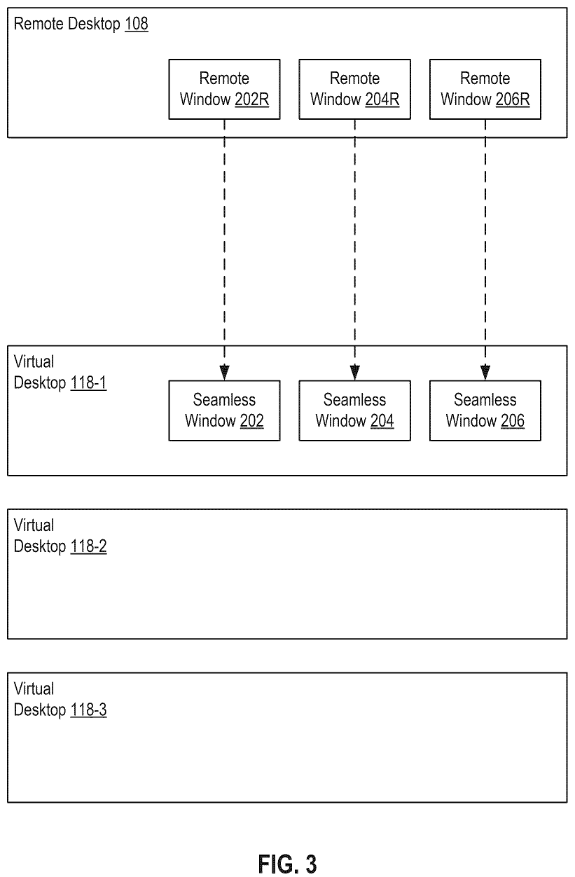

FIG. 3 is a schematic representation of local and remote windows in a remote desktop environment according to some embodiments. Continuing with the example of FIG. 2, assume that the remote desktop session has been interrupted (e.g., either intentionally by the user or due to some unintentional factor such as a network disruption). Assume further that the remote desktop server 104 maintains remote desktop 108 having remote windows 202R, 204R, and 206R despite the interruption. That is, remote desktop server 104 does not terminate remote desktop 108 in response to the interruption of the remote desktop session. FIG. 3 shows an example where the user has reconnected the remote desktop session, but where the remote desktop system is agnostic to seamless window affinity with the virtual desktops. In such case, remote desktop client 112 cooperates with local OS 114 to display seamless windows 202, 204, and 206 on virtual desktop display 118-1 (in this example). The affinity of each seamless window 202, 204 and 206 to its virtual desktop 118-1, 118-2, and 118-3 as determined by the user (shown in FIG. 2) has not been maintained. As described in embodiments below, remote desktop client 112 and remote desktop server 104 cooperate to maintain seamless window and virtual desktop affinity despite interruption of the remote desktop session due to user action, network disruption, or the like.

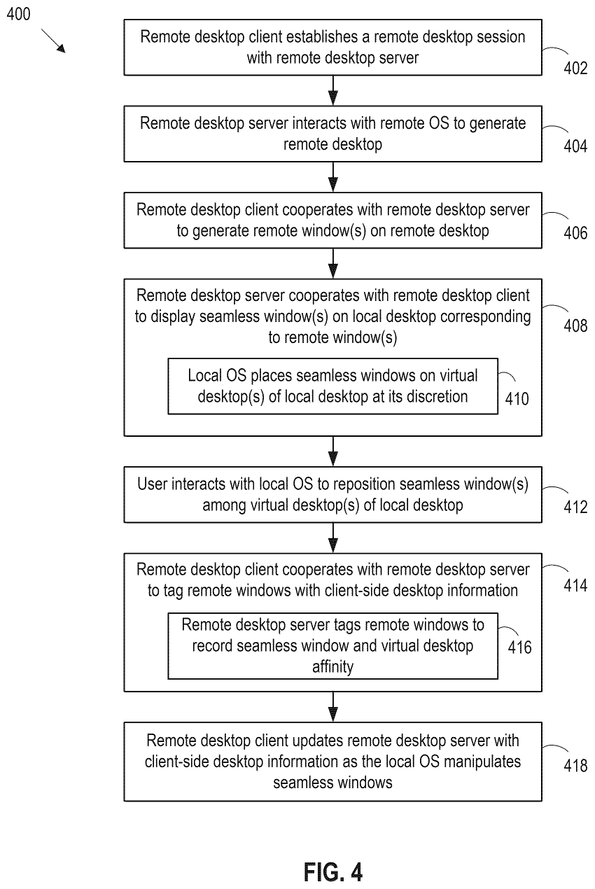

FIG. 4 is a flow diagram depicting a method 400 of establishing a remote desktop session according to some embodiments. Method 400 begins at step 402, where remote desktop client 112 establishes a remote desktop session with remote desktop server 104. Any well-known authentication/authorization technique can be used when establishing the remote desktop session. At step 404, remote desktop server 104 interacts with remote OS 106 to generate remote desktop 108. At step 406, remote desktop client 112 cooperates with remote desktop server 104 to generate remote window(s) on remote desktop 108. For example, the user can interact with local OS 114 and/or remote desktop client 112 to launch one or more applications on remote computer 102, which causes creation of window(s) on remote desktop 108 referred to as remote windows.

At step 408, remote desktop server 104 cooperates with remote desktop client 112 to display seamless window(s) on local desktop 116 corresponding to remote window(s) on remote desktop 108 (e.g., one seamless window for each remote window). Each seamless window shows the contents of its corresponding remote window. At step 410, local OS 114 places the seamless window(s) on virtual desktop(s) 118 at its discretion. For example, local OS 114 can display the seamless window(s) on the active desktop. At step 412, the user interacts with local OS 114 to reposition one or more of the seamless window(s) among virtual desktops 118. An example is shown in FIG. 2, where seamless windows 202, 204, and 206 are displayed on virtual desktops 118-1, 118-2, and 118-3, respectively.

At step 414, remote desktop client 112 cooperates with remote desktop server 104 to tag remote windows with client-side desktop information. Techniques for tagging remote windows are described below. Embodiments of client-side desktop information are described below. In general, client-side desktop information includes any information related to the affinity of each seamless window and its respective virtual desktop. In general, tagging a remote window involves persisting the affinities on the server side (e.g., on remote computer 102) in association with the respective remote windows. Thus, at step 416, remote desktop server 104 tags each remote window with an affinity of its respective seamless window and the virtual desktop on which the seamless window is displayed. At step 418, remote desktop client 112 updates remote desktop server 104 with client-side desktop information as local OS 116 manipulates seamless windows (e.g., through user interaction).

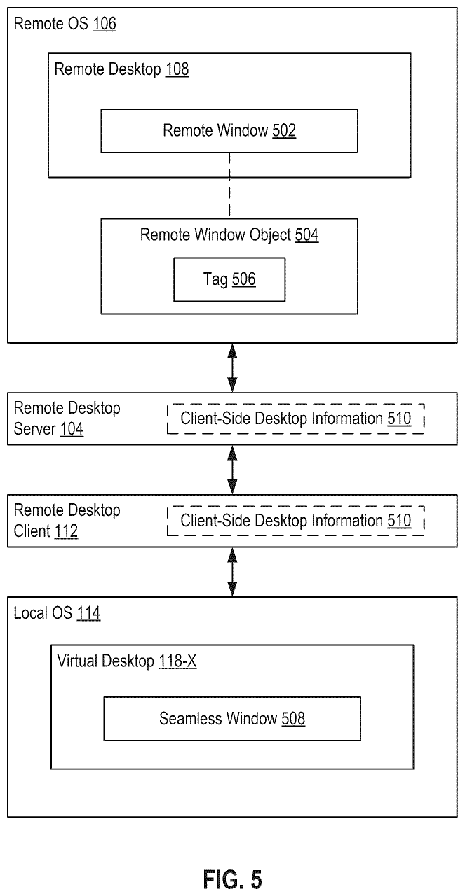

FIG. 5 is a block diagram depicting remote window tagging according to some embodiments. In the example, remote desktop 108 displays a remote window 502. Local OS 114 displays a corresponding seamless window 508 on a virtual desktop 118-X (where X indicates an arbitrary one of virtual desktops 118). Remote OS 106 maintains a remote window object 504 corresponding to remote window 502. Remote window object 504 is an object of a type defined by an application programming interface (API) of remote OS 106. Remote window object 504 can include data fields and procedures, including a tag data field (“tag 506”), a procedure for setting tag 506, and a procedure for retrieving the value of tag 506.

In an embodiment, at step 414 of method 400, remote desktop client 112 sends client-side desktop information to remote desktop server 104, where the client-side desktop information includes an affinity between each seamless window and its respective virtual desktop on which it is displayed. This information can comprise, for example, an integer or other type of value that identifies the virtual desktop for each seamless window. For example, remote desktop client 112 sends a value representing virtual desktop 118-X to remote desktop server 104 for seamless window 508. Remote desktop server 104 tags remote window 502 with the client-side desktop information by calling the set tag procedure of remote window object 504. Thus, the information (e.g., value) is persisted as tag 506 in remote window object 504 for remote window 502.

In another embodiment, the client-side desktop information can include more than just one value that identifies a virtual desktop. Additional information can include, for example, the size of a seamless window, its position on the virtual desktop, its state (minimized, maximized, etc.), and the like. In some embodiments, tag 506 can be a structure or other type of object that is capable of storing the various parameters of the client-side desktop information. However, in other embodiments, tag 506 can only store a value. In such case, remote desktop server 104 can maintain an object for storing client-side desktop information 510. Remote desktop server 104 can call the set tag procedure to set tag 506 with a pointer value that points to or otherwise identifies client-side desktop information 510. A pointer may be an address in the memory. Client-side desktop information 510 can be stored in memory starting at an address and a pointer can be set to that address. Software can call the get tag procedure of remote window object 504 to obtain the pointer value of tag 506, and then use that pointer value to access client-side desktop information 510. Remote desktop server 104 and remote desktop client 112 can maintain copies of client-side desktop information 510 and keep them synchronized. The version of client-side desktop information 510 maintained by remote desktop server 104 can be the source-of-truth.

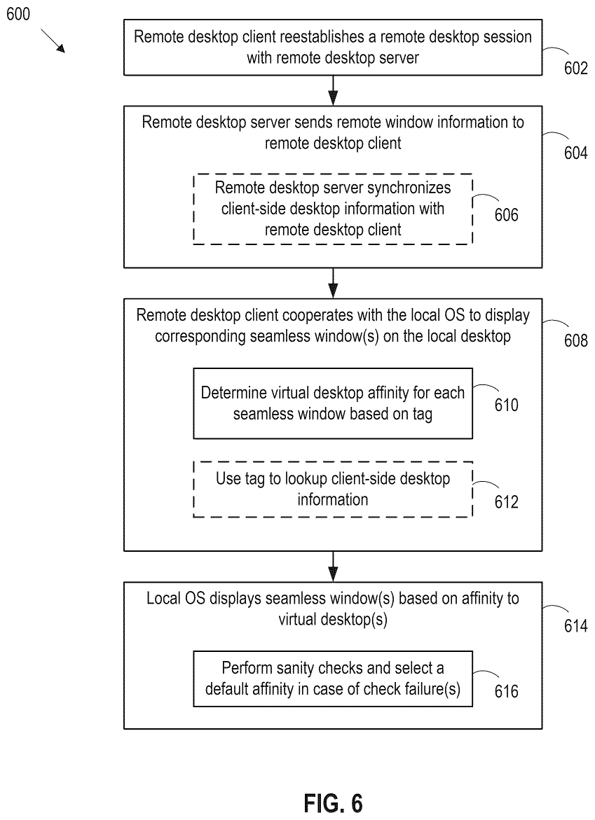

FIG. 6 is a flow diagram depicting a method 600 of reestablishing a remote desktop session after interruption according to some embodiments. Method 600 begins at step 602, where remote desktop client 112 reconnects a remote desktop session with remote desktop server 104. At step 604, remote desktop server 104 sends remote window information to remote desktop client 112. The remote window information includes information that describes the remote windows, such as all or a portion of the data of remote window objects associated with the remote windows maintained by remote OS 106. In embodiments, the remote window information includes the tag for each remote window. In embodiments where remote desktop server 104 maintains client-side desktop information 510 referenced by tags, remote desktop server 104 can synchronize this data with remote desktop client 112 (step 606).

At step 608, remote desktop client 112 cooperates with local OS 114 to display the corresponding seamless window(s) on local desktop 116. At step 610, remote desktop client 112 determines virtual desktop affinity for each seamless window based on the tag in its remote window object sent by remote desktop server 104. In embodiments where the tag is a pointer to client-side desktop information, at step 612, remote desktop client 112 uses the tag to lookup client-side desktop information for each seamless window, including the virtual desktop affinity.

At step 614, local OS 114 displays the seamless window(s) based on affinity to the virtual desktop(s) as determined from the tags. At step 616, remote desktop client 112 and/or local OS 114 can perform checks on client-side desktop information, such as virtual desktop affinity, to confirm its validity. For example, whether an identified virtual desktop exists. In case of check failure, remote desktop client 112 can cooperate with local OS 114 to apply default information for the affected seamless window(s) (e.g., display a seamless window on a default virtual desktop in case the identified virtual desktop is not available).

In this manner, after reestablishing a remote desktop session, the seamless windows are positioned among the virtual desktops as expected by the user. That is, the example of FIG. 2 is maintained even after the interruption and reestablishing of the remote desktop session.

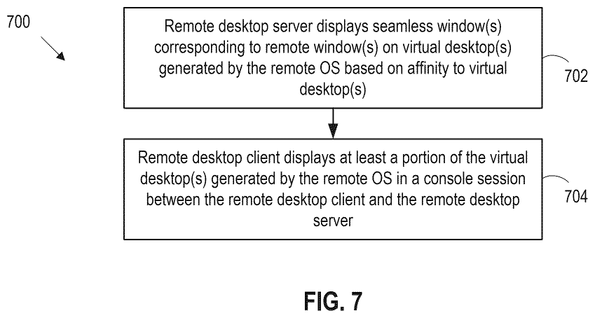

FIG. 7 is a flow diagram depicting a method of establishing a remote desktop session according to some embodiments. Prior to method 700, it is assumed method 400 is performed to establish affinity between seamless window(s) and virtual desktop(s). Method 700 begins at step 702, where remote desktop server 104 displays seamless window(s) corresponding to remote window(s) on virtual desktop(s) generated by remote OS 106 based on the affinity between seamless window(s) and virtual desktop(s). In some embodiments, remote OS 106 can include the same or similar capabilities as local OS 114. Remote OS 106 can generate virtual desktops similar to virtual desktops 118 generated by local OS 114. Remote OS 106 can generate its local desktop that can display these virtual desktop(s). In some embodiments, remote desktop client 112 can establish a console session with remote desktop server 104. A console session may be a remote session that displays all or a portion of console 107. At step 704, remote desktop client 112 displays at least a portion of the virtual desktop(s) generated by remote OS 106 in a console session between remote desktop client 112 and remote desktop server 104. Thus, the seamless window and virtual desktop affinity can be utilized in reconnection of a remote desktop session, as in FIG. 6, and also in connection of a console session as in FIG. 7. Transition between a remote desktop session and a console session may be referred to as “roaming” between the sessions.

In method 400 of FIG. 4, local OS 114 places seamless windows on virtual desktop(s) of the local desktop and sends tags for the affinity to remote desktop server 104. In other embodiments, remote OS 106 can perform the same functionality as local OS 114 on its local desktop. For example, a user can establish a console session between remote desktop client 112 and remote desktop server 104. The user can interact with remote OS 106 in the console session to reposition seamless window(s) among virtual desktop(s) of the remote OS's local desktop. In method 600 of FIG. 6, the user reestablishes a remote desktop session with remote desktop server 104. In some embodiments, method 600 can be performed but in response to roaming from a console session to a remote desktop session at remote desktop client 112 rather than in response to reestablishing a remote desktop session.

In some embodiments, a remote session delivers seamless windows while passing through one or more computers in addition to the client and the server that are maintaining the remote session (referred to as “nested sessions”). In case of nested sessions, affinity information collection and tag application does not change. Affinity is collected by the client and stored by the remote server. At the stage of reconnection, the client is reexamined for desired feature support so that affinity can be restored, while any intermediary computers are only involved in passing the tagging information via common techniques intrinsic to nested sessions.

In the embodiments described above, affinity is determined between a seamless window and a virtual desktop that comprises a desktop. Operating systems can support additional types of virtual desktops to which seamless windows can have affinity. For example, an operating system can partition a desktop into multiple regions into which different windows fit or “snap.” These different regions can include identifiers similar to how virtual desktops are identified. In such an example, a virtual desktop can be one of these regions of a desktop rather than an entire desktop. Remote desktop client 112 can capture these different types of affinities for seamless windows.

While present invention does not rely or assume virtual desktop support by the remote server, nor does it require additional feature, like “snapping” to be implemented on the server machine, it is understood that the remote server OS is not precluded from native support of either feature. These capabilities do not come into play when remote sessions are involved as they are not needed for remote session scenarios to work, solely relying on the client and server side to maintain the affinity relationship for associated seamless windows. However, in situations where session reconnect involves direct server access, the same tagging implementation should allow proper affinity restoration. This time based on the native support for the above features that can be referenced based on the remote window tags, where these former remote windows become local windows without involvement of seamless window intermediaries, but the tags can be used to restore the associated affinity.

Virtual desktop affinity for seamless remote desktop windows has been described. In some embodiments, the process of launching seamless applications works as follows: A remote desktop client on a local computer connects to a remote desktop server on a remote computer. The connection, a remote desktop session, optionally uses authentication. The remote desktop session results in sharing peripheral(s) and feature(s) of the local OS with the remote OS. Following the connection, the server adjusts the layout of the remote desktop to match the local desktop (e.g., desktop size). Local resources, such as hard drives, file shares, clipboard, specialized hardware, etc. are connected to the server as determined by administrative policies from the client, the server, or both. Interactive applications can be launched on the server by either the server or the client, allowing the client to access and interact with the applications' user interfaces. Although specifics can differ between vendors, the application windows are displayed on the client's local desktop as if they were local in seamless windows. User interactions with the seamless windows, such as moving, resizing, repositioning, etc. are communicated to the server and applied to the server-side windows (remote windows). Significant efforts have been invested to integrate seamless applications closely with the client's local environment, making these windows indistinguishable from those of locally run applications, hence fulfilling the ‘seamless’ aspect.

Executing remote applications is subject to the risk of network disconnections, potentially interrupting the communication between the client and server, whether intentionally or accidentally. If a disconnection occurs, remote applications continue to run on the server unless a session termination is initiated. These disconnected states are designed to enable users to reconnect from either the same or a different client computer and resume their work with the remote seamless applications, even if there have been changes in topology, peripherals, or the client's operating system. Upon reconnection, the server updates the client about the seamless applications and requests the creation of client-side representations like windows, icons, toolbars, and thumbnails, which mimic the remote server's artifacts initialized with a prior session. The redirection of local resources is renegotiated based on the currently available resources on the client.

Despite the evolution of client operating systems, not all features are consistently mirrored in seamless application updates, particularly the integration with virtual desktops. The techniques described herein ensure that seamless applications can be integrated smoothly with virtual desktops. When establishing a connection, the client informs the server about the available virtual desktops and their specifics, maintaining session consistency upon reconnecting. This includes the association of windows with virtual desktops, ensuring the correct placement of virtual desktop windows according to changes in the client's desktop configuration. In some embodiments, this is accomplished with per server-side window tagging. This information can be continually updated from client to server during the connection, utilized upon reconnection, and discarded when the corresponding window is closed.

If the client operating system supports virtual desktops and the remote server is reconnecting to a client, while a seamless application on that server is already running, the server can verify each seamless window's tags and confirm the existence of desired virtual desktops. If necessary, missing desktops can be created on the client before recreating the local client-side windows that replicate the remote seamless windows and each placed on the desired desktop. If virtual desktops are not supported on the client, the default desktop can be used, and tags can be updated accordingly. Moreover, while tagging remote windows with virtual desktop identifiable information (desktop sequential number, name, etc.), the original window placement and client desktop topology (monitor size, number, and arrangement) can be included, to allow for adjusted placements of client-side windows upon reconnection. If monitors from the previous session are unavailable, a default window placement can be used. If expected monitors are present on the client, but are not connected, monitors can be reconnected, following desired resolution and topology, if applicable. Window placements are further adjusted in size and alignment to ensure consistency with the original setup prior to disconnect, accommodating modern OS features like tiling or snapping. The techniques described herein enhances the seamless application experience, ensuring continuity and user efficiency across virtual desktop environments, while addressing the dynamic nature of modern computing.

Managing seamless windows in a remote desktop system can be a technical problem, particularly due to lack of support by the local OS of the client. The techniques described herein provide a technical solution to the problem by implementing enhanced communication between remote desktop client and remote desktop server that includes exchange of seamless window and virtual desktop affinities. This improves operation of the local computer and the local OS executing thereon when displaying information to the user.

In some embodiments, both the local OS of the client and the remote OS of the server can support virtual desktops. When remote sessions with seamless windows are presented to users in the presence of virtual desktop support by the local OS of the client, it is assumed that even if the remote OS of the server is running the application that originated these windows does support virtual desktops on that server, it is immaterial to remote session windows, as seamless windows on the client side are governed by the virtual desktops on the client. It is possible in the presence of server-side virtual desktop support to move any window on that server, represented by seamless window or not, to these server-side virtual desktops away from the active virtual desktop that is presenting seamless windows to the client. Once server-side windows are moved to a non-active, i.e. invisible, virtual desktop, these windows can no longer be represented by seamless windows on the client and thus become inaccessible to the end user. Seamless windows are unlikely to encounter this confusing behavior unless the following use case is enacted: (1) A user connects directly to the computer console without creation of a remote session and uses the server in a traditional sense as a desktop workstation (i.e., the user is physical present at the remote server); (2) the user launches an application directly at that server, the application that is also accessible to that user via remote session with seamless window capabilities; (3) the user steps away from the console and accesses that very server remotely by launching that application in a seamless window mode via a remote session. This mechanism is similar to user roaming between different remote clients. Assuming a console session had utilizes multiple virtual desktops prior to reconnection from a remote client, embodiments herein allow the user the expected behavior for seamless windows. In some embodiments, there are three scenarios described below.

A first scenario covers a server console to remote session roaming use case. Application windows that were placed on a non-active virtual desktop are tagged with the affinity information for that desktop. Windows on the active desktop do not require tagging but can be tagged anyway for consistency of the approach. On a remote session reconnect, only windows on the active server-side desktop could be represented on the remote client as seamless windows. Windows on non-active server-side virtual desktops can be moved to the active server-side desktop to be allowed to display on the client as a seamless window. By using window tagging on that server, one can now rearrange seamless windows per virtual desktop affinity on the client side. Client-side virtual desktops can be created as needed similar to mechanisms described above, following tag assignments.

A second scenario covers a remote session to server console roaming use case. A user launches a remote session with an application from a remote server responsible for seamless windows visible on the client. With the client's OS ability to support virtual desktops these windows can be distributed between these virtual desktops per user's wishes. Each window's virtual desktop affinity is collected on the client and corresponding windows on the server are tagged, so the affinity relationship is preserved unless window placement is changed or window is terminated. The same user executing the roaming procedure from remote session to the local server console is to experience expected window behavior and placement if: (1) The user's login to the server amounts to a reconnect to the already running desktop environment on that server with that user identity. Each window, previously displayed as a seamless window on the client, should have retained their respective tags and are all located on the active virtual desktop. (2) Per windows tagged virtual desktops are created as needed and window's virtual desktop affinity is reconciled to present the user with an identical desktop environment layout and window placements as before, prior to roaming from remote session to console.

A third scenario covers a remote session to a remote session roaming use case. As with scenario two above, a user launches a remote application and displays seamless windows on the client. Seamless windows are moved between virtual desktops on the client, while server-side windows are kept apprised on the virtual desktop affinity via server-side window tagging. The user then moves to a different client machine and reconnects to the prior remote session. In case when the new client machine supports virtual desktops, virtual desktop affinity is restored using the window tags from the remote server. If virtual desktops are not supported at the new client machine, no changes to seamless windows are expected and the server-side window tags should be discarded or ignored.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in userspace on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. In some cases, if and where relevant, “virtualized computing instance” can encompass both VMs and containers.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary in some embodiments, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of displaying windows in a remote desktop system, comprising:
obtaining, by a remote desktop client executing on a local computer having a local operating system (OS), information relating a first window to a first virtual desktop generated by the local OS;
sending the information from the remote desktop client to a remote desktop server;
setting, by the remote desktop server, a tag in a remote window object representing a remote window that corresponds to the first window based on the information, the remote window generated by a remote OS on a remote computer;
receiving, at the remote desktop client, at least a portion of the remote window object including the tag; and
displaying, by the remote desktop client in cooperation with the local OS based on the tag, the first window on the first virtual desktop.

2. The method of claim 1, wherein the first window comprises a seamless window that displays contents of the remote window.

3. The method of claim 1, wherein the information comprises a value that identifies the first virtual desktop.

4. The method of claim 2, wherein the remote desktop server sets the tag to the value that identifies the first virtual desktop.

5. The method of claim 1, wherein the remote desktop stores the information and sets the tag to a pointer to the information as stored.

6. The method of claim 1, wherein the first virtual desktop comprises a desktop generated by the local OS.

7. The method of claim 1, wherein the first virtual desktop comprises a region of a desktop generated by the local OS.

8. The method of claim 1, wherein the remote desktop client performs the steps of obtaining and sending in a remote desktop session, and wherein the remote desktop client performs the steps of receiving and displaying in response to reconnection of the remote desktop session.

9. The method of claim 1, further comprising:
displaying, by the remote desktop server in cooperation with the remote OS based on the tag, a second window on a second virtual desktop generated by the remote OS; and
displaying, by the remote desktop client, at least a portion of the second virtual desktop in a console session between the remote desktop client and the remote desktop server.

10. A non-transitory computer readable medium comprising instructions to be executed in a computing device to cause the computing device to carry out a method of displaying windows in a remote desktop system, comprising:
obtaining, by a remote desktop client executing on a local computer having a local operating system (OS), information relating a first window to a first virtual desktop generated by the local OS;
sending the information from the remote desktop client to a remote desktop server;
setting, by the remote desktop server, a tag in a remote window object representing a remote window that corresponds to the first window based on the information, the remote window generated by a remote OS on a remote computer;
receiving, at the remote desktop client, at least a portion of the remote window object including the tag; and
displaying, by the remote desktop client in cooperation with the local OS based on the tag, the first window on the first virtual desktop.

11. The non-transitory computer readable medium of claim 10, wherein the first window comprises a seamless window that displays contents of the remote window.

12. The non-transitory computer readable medium of claim 10, wherein the information comprises a value that identifies the first virtual desktop.

13. The non-transitory computer readable medium of claim 12, wherein the remote desktop server sets the tag to the value that identifies the first virtual desktop.

14. The non-transitory computer readable medium of claim 10, wherein the remote desktop stores the information and sets the tag to a pointer to the information as stored.

15. The non-transitory computer readable medium of claim 10, wherein the first virtual desktop comprises a desktop generated by the local OS.

16. The non-transitory computer readable medium of claim 10, wherein the first virtual desktop comprises a region of a desktop generated by the local OS.

17. A computing system, comprising:
a local computer executing a local operating system (OS) that generates a local desktop, the local desktop comprising a first virtual desktop;
a remote desktop client executing on the local computer and configure to:
obtain information relating a first window to the first virtual desktop;
send the information to a remote desktop server, the remote desktop server setting a tag in a remote window object representing a remote window that corresponds to the first window based on the information, the remote window generated by a remote OS on a remote computer;
receive at least a portion of the remote window object including the tag; and
display, in cooperation with the local OS based on the tag, the first window on the first virtual desktop.

18. The computing system of claim 17, wherein the first window comprises a seamless window that displays contents of the remote window.

19. The computing system of claim 17, wherein the information comprises a value that identifies the first virtual desktop and wherein the remote desktop server sets the tag to the value that identifies the first virtual desktop.

20. The computing system of claim 17, wherein the remote desktop stores the information and sets the tag to a pointer to the information as stored.
